SEQUENCE LISTING (8 sequences)

SEQ ID NO: 1 - protein, 524 aa, Paenibacillus polymyxa
VVHGQTAKTITIKVDTFKDRKPISPYIYGTNQDLAGDENMAARRLGGNRMTGYNWENNMSNAGSDWQHSSDNYLCSNGGLTQAECEKPGAVVTSFHDQSLKLGTYSLVTLPMAGYVAADGNGSVQESEAAPSARWNQVVNAKNAPFQLQPDLNDNYVYVDEFVHFLVNKYGTASTKAGVKGYALDNEPALWSHTHPRIHPEKVGAKELVDRSVSLSKAVKAIDAGAEVFGPVLYGFGAYKDLQTAPDWDSVKGNYSWFVDYYLDQMRLSSQVEGKRLLDVFDVHWYPEAMGGGIRITNEVGNDETKKARMQAPRTLWDPTYKEDSWIAQWFSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 2 - protein, 294 aa, Sordaria fimicola
MRSSTILQTGLVAVLPFAVQAASGSGKSTRYWDCCKPSCAWSGKASVNRPVLACDANNNPLNDANVKSGCDGGSAYTCANNSPWAVNDNLAYGFAATKLSGGTESSWCCACYALTFTSGPVSGKTLVVQSTSTGGDLGSNHFDLNMPGGGVGLFDGCKREFGGLPGAQYGGISSRSECDSFPAALKPGCQWRFDWFKNADNPEFTFKQVQCPSELTSRTGCKRNDDSQFPAFTPPSGGGSNPSTPTTPPSSGGGGSGCAAAMYAQCGGSGFSGCTNCPSGSTCKAINDYYHQCA

SEQ ID NO: 3 - protein, 305 aa, Humicola insolens
MRSSPLLRSAVVAALPVLALAADGRSTRYWDCCKPSCGWAKKAPVNQPVFSCNANFQRITDFDAKSGCEPGGVAYSCADQTPWAVNDDFALGFAATSIAGSNEAGWCCACYELTFTSGPVAGKKMVVQSTSTGGDLGSNHFDLNIPGGGVGIFDGCTPQFGGLPGQRYGGISSRNECDRFPDALKPGCYWRFDWFKNADNPSFSFRQVQCPAELVARTGCRRNDDGNFPAVQIPSSSTSSPVNQPTSTSTTSTSTTSSPPVQPTTPSGCTAERWAQCGGNGWSGCTTCVAGSTCTKINDWYHQCL

SEQ ID NO: 4 - protein, 299 aa, Thielavia terrestris
MRSTPVLRTTLAAALPLVASAASGSGQSTRYWDCCKPSCAWPGKAAVSQPVYACDANFQRLSDFNVQSGCNGGSAYSCADQTPWAVNDNLAYGFAATSIAGGSESSWCCACYALTFTSGPVAGKTMVVQSTSTGGDLGSNHFDIAMPGGGVGIFNGCSSQFGGLPGAQYGGISSRDQCDSFPAPLKPGCQWRFDWFQNADNPTFTFQQVQCPAEIVARSGCKRNDDSSFPVFTPPSGGNGGTGTPTSTAPGSGQTSPGGGSGCTSQKWAQCGGIGFSGCTTCVSGTTCQKLNDYYSQCL

SEQ ID NO: 5 - protein, 295 aa, Staphylotrichum coccosporum
ADGKSTRYWDCCKPSCSWPGKASVNQPVFACSANFQRISDPNVKSGCDGGSAYACADQTPWAVNDNFSYGFAATSISGGNEASWCCGCYELTFTSGPVAGKTMVVQSTSTGGDLGTNHFDLAMPGGGVGIFDGCSPQFGGLAGDRYGGVSSRSQCDSFPAALKPGCYWRFDWFKNADNPTFTFRQVQCPSELVARTGCRRNDDGNFPVFTPPSGGQSSSSSSSSSAKPTSTSTSTTSTKATSTTSTASSQTSSSTGGGCAAQRWAQCGGIGFSGCTTCVSGTTCNKQNDWYSQCL

SEQ ID NO: 6 - protein, 464 aa, Paenibacillus polymyxa
NAGSDWQHSSDNYLCSNGGLTQAECEKPGAVVTSFHDQSLKLGTYSLVTLPMAGYVAADGNGSVQESEAAPSARWNQVVNAKNAPFQLQPDLNDNYVYVDEFVHFLVNKYGTASTKAGVKGYALDNEPALWSHTHPRIHPEKVGAKELVDRSVSLSKAVKAIDAGAEVFGPVLYGFGAYKDLQTAPDWDSVKGNYSWFVDYYLDQMRLSSQVEGKRLLDVFDVHWYPEAMGGGIRITNEVGNDETKKARMQAPRTLWDPTYKEDSWIAQWFSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 7 - protein, 272 aa, Neurospora tetrasperma
ASGSGQSTRYWDCCKPSCSWSGKASVNRPVLACDANNNPLSDASVKSGCDGGSAYTCANNSPWAVNDQLSYGFAATKLSGGTESSWCCACYALTFTSGPVAGKTMVVQSTSTGGDLGSNHFDINMPGGGVGLFDGCTRQFGGLPGAQYGGISSRSQCDSFPAALKPGCQWRFDWFQNADNPNFTFKQVQCPSELTSRTGCKRNDDSQFPVFTPPSGGGTNPSTPTTPPSSGGGSGCTADKYAQCGGSGWSGCTNCPSGSTCKTINDYYHQCA

SEQ ID NO: 8 - protein, 773 aa, Alkalihalobacillus akibai
AEGNTREDNFKHLLGNDNVKRPSEAGALQLQEVDGQMTLVDQHGEKIQLRGMSTHGLQWFPEILNDNAYKALANDWESNMIRLAMYVGENGYASNPELIKSRVIKGIDLAIENDMYVIVDWHVHAPGDPRDPVYAGAEDFFRDIAALYPNNPHIIYELANEPSSNNNGGAGIPNNEEGWNAVKEYADPIVEMLRDSGNADDNIIIVGSPNWSQRPDLAADNPINDHHTMYTVHFYTGSHAASTESYPPETPNSERGNVMSNTRYALENGVAVFATEWGTSQANGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSADGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEE

(19) United States
(12) Patent Application Publication
(10) Pub. No.: US 2024/0141259 A1
(43) Pub. Date: May 2, 2024

(54) USE OF ENZYMES FOR IMPROVING FRAGRANCE DEPOSITION

(71) Applicants: Novozymes A/S, Bagsvaerd (DK); Givaudan SA, Vemier (CH)

(72) Inventors: Leigh Murphy, Roskilde (DK); Elisabeth Rinaudo, Argenteuil (FR)

(73) Assignees: Novozymes A/S, Bagsvaerd (DK); Givaudan SA, Vernier (CH)

(21) Appl. No.: 18/548,506

(22) PCT Filed: Feb. 25, 2022
(86) PCT No.: PCT/EP2022/054772

§ 371 Date: Sep. 1, 2023

(30) Foreign Application Priority Data
Mar. 1, 2021 (EP) 21159991.5

(51) Int. Cl. C11D 3/386; C11D 3/00; C11D 3/50

(52) U.S. Cl. CPC C11D 3/38645; C11D 3/0015; C11D 3/50

(57) ABSTRACT

The use of an enzyme having cellulase activity for improving deposition of a fragrance from a consumer product composition, such as a fabric conditioner composition or a scent booster composition onto a textile treated with the fabric conditioner composition.

### FIELD OF THE INVENTION

The invention is generally concerned with methods and compositions for optimizing the deposition of fragrance from consumer product compositions onto textiles. More particularly, the invention is concerned with optimizing deposition of fragrance from consumer products that are designed with the purpose of maximizing the delivery of fragrance onto textiles, such as fabric conditioner compositions and laundry scent boosters.

### REFERENCE TO A SEQUENCE LISTING

This application contains a Sequence Listing in computer readable form. The computer readable form is incorporated herein by reference.

### BACKGROUND OF THE INVENTION

Increasingly, consumers demand impactful and long-lasting fragrance on their laundry, even weeks after washing. It is also desirable to enhance consumer experience by releasing fragrance at different consumer contact points, such as point of purchase, when opening the door of a washing machine or dryer, as well as during the storage, ironing and wearing of clothing. Detergents, fabric conditioner compositions and scent booster compositions enable consumers to enjoy the magical fragrance experience during these different stages of the laundry care process.

Fabric conditioner compositions are water-based textile conditioning compositions primarily intended to be added to the rinse-cycle during a conventional clothes-washing process. The major component of a fabric conditioner composition is a cationic surfactant, which softens textile and offers static control. Apart from this surfactant, they typically contain minor amounts of other materials, such as emulsifiers. It is known to add cellulases to fabric conditioner compositions. In particular, enzymes have been employed to improve the condition of textiles (e.g. reduce pilling), and as well to improve water-absorbency of textiles. It is also conventional for fabric conditioner compositions to include aesthetic additives, such as colours and perfumes.

With consumer demand for smaller dosage formats (e.g. unit dosage forms) and the general public interest to reduce the consumption of our planet's resources in order to satisfy our consumer product needs, there is a desire to reduce the solids content in these products. In order to achieve this, it is necessary to reduce levels of the major component used in these products, i.e. cationic surfactants, whilst still delivering excellent conditioning performance and textile care.

Although it is conventional to think of perfume as merely an aesthetic ingredient, in fact it is not used in consumer product compositions simply to ensure the compositions and textiles treated with them smell wonderful. Consumers actually benefit from additional value brought to their consumer products by perfume design. The ability of a perfume to enhance the attributes of a consumer product has been known to manufacturers of consumer products for decades. The pleasant odour remaining on a shirt after ironing informs the wearer that not only is it clean and fresh, but it is almost new again. The user of a deodorant stays “fresh” even after a hard day at the office. The floor cleaner has not only cleaned the floor, but the room remains “clean” after many hours.

Skilled perfumers can achieve all manner of such secondary functional benefits because they understand how perfumes interact with the complex chemistry used in consumer products, as well as the chemistry of the targeted substrates. For example, it is generally known that the softness of laundered garments is achieved by delivering a cationic surfactant to the surface of the fabric. It is also known that perfume ingredients associate with surfactant aggregates and absorption of perfume is concomitant with the deposition of cationic surfactants on a textile. In this way, cationic surfactants actually promote perfume deposition and therefore perfume impact on freshly laundered fabrics. Furthermore, if the perfumer uses perfume ingredients that are empirically known to deposit well on fabric, then the initial deposition on wet fabric can be translated into improved perfume tenacity and odour impact during dry down and subsequently during storage and use by consumers. Conversely, reducing the level of cationic surfactants may reduce the deposition of perfume and limit its olfactive performance on both wet and dry stages of the washing cycle.

There remains a need to optimize the design of consumer products to improve deposition of fragrance onto textiles in order to improve fragrance impact on textiles, and to minimize wastage of fragrance discarded in the washing liquor. Furthermore, there is a particular need, in regards to fabric conditioner compositions to reduce levels of cationic surfactant used in these compositions, but without compromising either fabric care or perfume deposition performance.

### SUMMARY OF THE INVENTION

In addressing the short-comings in the prior art, the applicant found in a surprising manner that the addition of cellulase enzymes to consumer products can improve the deposition of fragrance on to textiles. Furthermore, in regards to fabric conditioner compositions, the use of cellulase enzymes also allows one to reduce levels of cationic surfactants without compromising fabric care or fragrance deposition.

Still further, owing to the fact that cationic surfactants employed in fabric conditioner compositions are derived from non-renewable petrochemical resources, the present invention is able to deliver more sustainable fabric conditioner compositions by reducing the cationic surfactant load by means of the addition of cellulase enzymes

Accordingly, the invention provides in a first aspect the use of a cellulase enzyme for improving deposition of a fragrance from consumer product compositions, such as fabric conditioner compositions or scent booster compositions, onto a textile treated with the composition.

In another aspect the invention provides a method of improving the deposition of a fragrance from a consumer product composition, such as a fabric conditioner composition or a scent booster composition, onto a textile treated with the composition, the method comprising the step of adding a cellulase enzyme to the composition.

In yet another aspect, the present invention provides a fabric conditioner composition for use in improving the deposition of fragrance onto a textile, wherein the conditioner composition comprises a cationic surfactant, fragrance and a cellulase enzyme.

In yet another aspect, the invention provides a fabric conditioner composition to provide substantive perfume delivery to a textile and an enduring perfume impact, even after rinsing and drying steps, that is detectable by people with normal olfactive acuity, the conditioner composition comprising an effective amount of a cellulase enzyme.

The details, examples and preferences provided in relation to any one or more of the stated aspects of the present invention will be further described herein and apply equally to all aspects of the present invention. Any combination of the embodiments, examples and preferences described herein below in all possible variations thereof is encompassed by the present invention unless otherwise indicated herein, or otherwise clearly contradicted by context.

### DEFINITIONS

Cellulase: The term “cellulolytic enzyme” or “cellulase” or “enzyme having cellulase activity” means one or more (e.g., several) enzymes that catalyze the decomposition of cellulosic material by hydrolysis of beta-1,4-glycosidic bonds. Such enzymes include endoglucanase(s), cellobiohydrolase(s), beta-glucosidase(s), or combinations thereof. The two basic approaches for measuring cellulolytic activity include: (1) measuring the total cellulolytic activity, and (2) measuring the individual cellulolytic activities (endoglucanases, cellobiohydrolases, and beta-glucosidases) as reviewed in Zhang et al., Outlook for cellulase improvement: Screening and selection strategies, 2006, Biotechnology Advances 24: 452-481. Total cellulolytic activity is usually measured using insoluble substrates, including Whatman No.1 filter paper, microcrystalline cellulose, bacterial cellulose, algal cellulose, cotton, pretreated lignocellulose, etc. The most common total cellulolytic activity assay is the filter paper assay using Whatman No1 filter paper as the substrate. The assay was established by the International Union of Pure and Applied Chemistry (IUPAC) (Ghose, 1987, Measurement of cellulase activities, Pure Appl. Chem. 59: 257-68).

For purposes of the present invention, cellulolytic enzyme activity may be determined by measuring the increase in hydrolysis of a cellulosic material by cellulolytic enzyme(s) under the following conditions: 1-50 mg of cellulolytic enzyme protein/g of cellulose in PCS (or other pretreated cellulosic material) for 3-7 days at a suitable temperature, e.g., 50° C., 55° C., or 60° C., compared to a control hydrolysis without addition of cellulolytic enzyme protein. Typical conditions are 1 ml reactions, washed or unwashed PCS, 5% insoluble solids, 50 mM sodium acetate pH 5, 1 mM MnSO4, 50° C., 55° C., or 60° C., 72 hours, sugar analysis by AMINEX® HPX-87H column (Bio-Rad Laboratories, Inc., Hercules, CA, USA).

Fabric softener: A Fabric softener (also referred to herein as fabric conditioner, fabric conditioner composition or solely softener) is a composition that is typically applied to laundry during the rinse cycle in a washing machine or when washing by hand. Fabric softeners coat the surface of a fabric with chemical compounds that are electrically charged, neutralizing the charge of the fabric and causing threads to “stand up” from the surface so the fabric feels softer and makes it fluffier. Fabric softeners are available as solutions and solids and may also be impregnated in dryer sheets used in a clothes dryer.

Fabric softener agent: A fabric softener agent (or a softener agent) is an ingredient that is comprised in fabric softener compositions such as chemical compounds that are electrically charged. These compounds cause threads in the fabric to lift up from the surface of the textile and thereby give the fabric a softer feel of the textile. In one embodiment the fabric softener agent is one or more cationic softeners. The softener will usually comprise from about from about 0.5% to about 40% by weigh of a cationic surfactant, for example from about 0.5% to about 30%, in particular from about 1% to about 20%, from about 3% to about 10%, such as from about 3% to about 5%, from about 8% to about 12% or from about 10% to about 12%. Non-limiting examples of cationic surfactants include bis(Acyloxyethyl)hydroxyethyl Methylammonium Methosulphate, Dipalmoylethyl hydroxyethylmonium methosulfate, dihydrogenated tallow hydroxyethylmonium methosulfate, distearoylethyl hydroxyethylmonium methosulfate, dioleoyl ethyl hydroxyethylmonium methosulfate alkyl quaternary ammonium compounds, alkoxylated quaternary ammonium (AQA) compounds, other ester quats, and combinations thereof. The cationic softeners bind by electrostatic attraction to the negatively charged groups on the surface of the textile and neutralize their charge and thereby impart lubricity.

Fragment: The term “fragment” means a polypeptide having one or more (e.g., several) amino acids absent from the amino and/or carboxyl terminus of a mature polypeptide main; wherein the fragment has enzyme activity. In one aspect, a fragment contains at least 85%, e.g., at least 90% or at least 95% of the amino acid residues of the mature polypeptide of an enzyme.

Family GH45 cellulase: the term “family GH45 cellulase” as used herein, refers to Glycosyl hydrolases are enzymes that catalyze the hydrolysis of the glycosyl bond. There are over 100 classes of Glycosyl hydrolases which have been classified, see Henrissat et al. (1991) A classification of glycosyl hydrolases based on amino-acid sequence similarities', J. Biochem. 280: 309-316 and the CAZY website at www.cazy.org. The glycoside hydrolases of family 45 (GH45) have so far been identified as endoglucanase (EC 3.2.1.4). Within the definition falls enzymes which are commonly known as “cellulases”. Such enzymes comprise also enzymes that may be known as endoglucanases.

Rinse cycle: The term “rinse cycle” is defined herein as a rinsing operation wherein textile is exposed to water for a period of time by circulating the water and optionally mechanically treat the textile in order to rinse the textile and finally the superfluous water is removed. A rinse cycle may be repeated one, two, three, four, five or even six times at the same or at different temperatures.

Scent booster: A scent booster is a composition that is applied to textiles during the laundry process to impart a long-lasting fragrance impression to textiles particularly during dry stages such as storage, ironing or wearing of clothing. Scent boosters typically comprise free and/or encapsulated fragrance oil entrained in a solid matrix material. Typically a scent booster is presented in a granular or pastille format.

Sequence identity: The relatedness between two amino acid sequences or between two nucleotide sequences is described by the parameter “sequence identity”.

For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the —nobrief option) is used as the percent identity and is calculated as follows:

(Identical Residues×100)/(Length of Alignment−Total Number of Gaps in Alignment)

Textile: The term “textile” as it is used herein refers to any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof. The textile or fabric may also be blends of cellulose based and non-cellulose based fibers. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the term fabric or garment is used it is intended to include the broader term textiles as well.

The textile contemplated in the present invention may be any pure form, such as 100% cotton, 100% polyester or the like, or it may be any blend of different types of textile, such as 50% cotton and 50% polyester. Thus, in one embodiment, the textile is a mixture of at least 50% polyester and at least 20% cotton.

The textile may have been pre-washed (treated) in a laundering process. The laundering process may be done at various temperatures depending on the textile, the level of dirt on the textile, or any other aspect that may be dependent on the temperature. The invention is not limited to any specific temperature. Thus, in one embodiment, the pre-washing has been done at a temperature of at least 5° C., such as at least 10° C., at least 15° C., at least 20 ° C., at least 25° C., at least 30° C., at least 35° C., at least 40° C., at least 45° C., or at least 50° C., or at least 60° C.

Variant: The term “variant” means a polypeptide having enzyme activity comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding an amino acid adjacent to and immediately following the amino acid occupying a position.

Wash cycle: The term “wash cycle” is defined herein as a washing operation wherein textile is exposed to the wash liquor for a period of time by circulating the wash liquor and textile in a washing machine. A wash cycle may be repeated one, two, three, four, five or even six times at the same or at different temperatures. The wash cycle if often followed by a rinse cycle and finally a centrifugation cycle where water is removed from the textile. It is known for the skilled person to determine which is the wash cycle during laundry wash.

Wash liquor: The term “wash liquor” is intended to mean the solution or mixture of water and detergents optionally including enzymes used for laundry.

### DETAILED DESCRIPTION OF THE INVENTION

The present invention relates to the use of cellulase enzymes for improving the deposition of a fragrance on a textile by adding the enzymes to a consumer product composition. The invention relates particularly to the use of such enzymes to improve deposition of a fragrance onto a textile that is delivered by a fabric conditioner composition, but it also relates to other consumer product compositions, and particularly those whose efficacy is assessed by the level of fragrance that is deposited onto a textile, such as a scent booster. The applicants have found that by adding an enzyme to such compositions, the deposition of a fragrance onto a freshly laundered textile is improved compared to the performance of compositions not containing an enzyme. Furthermore, the applicants found that by judiciously selecting perfume ingredients, the perfume deposited on to textile during the wet stage of the washing process, clings to textiles with tenacity, such that a prolonged odour impression is detectable by people with normal olfactive acuity during dry-down and beyond through storage and subsequent use.

The invention also relates to a method for improving the condition of a textile comprising contacting the textile surface with a cellulase enzyme, and particularly a cellulase enzyme in combination with a cationic surfactant. In particular, in relation to fabric conditioner compositions, the applicants found that despite reducing the level of cationic surfactant employed in a fabric conditioner composition, conditioning and anti-static properties remain unaffected, but anti-pilling properties were nevertheless improved over multiple wash-cycles, by adding effective levels of a cellulase enzyme to the composition.

Cationic surfactants present in fabric conditioner compositions are derived from non-renewable petrochemical resources. Accordingly, another advantage of the present invention resides in the discovery that fabric conditioner composition can be rendered more sustainable by reducing the cationic surfactant load. The inventors achieved this by with the addition of a cellulase enzyme. Furthermore, a more sustainable composition can be obtained while not only maintaining but actually improving the performance of the perfume in the composition.

In contrast to many cationic surfactants used in fabric conditioner compositions, cellulases can be obtained from renewable agricultural sources, naturally found in the environment and readily biodegradable. The replacement of cationic surfactants by cellulases addresses the United Nations' Sustainable Development Goals, in particular Goal 12 “Responsible consumption and production”: replacing cationic surfactans with cellulase allows the producer—and thus the end user—to move from a potential fossil feedstock to a renewable feedstock and reduce the volume of persistent chemicals emitted to the environment.

The use of enzymes in surface-treatment compositions is commonly known in the art. By way of example, enzymes have been known to be useful as alternatives to chemical as optical whiteners. Furthermore, certain cellulase enzymes have been employed to remove fuzz and pills from fabric surfaces. And further still, in WO 2019/057758 the use of cellulases has been proposed to promote water-absorbency on fabrics treated with cationic surfactants. Indeed, the technical teaching in WO 2019/057758 that cellulase enzymes promote the penetration of water into treated fabric, teaches away from the present invention. If a cellulase is employed to promote the penetration of water into a fabric, this implies that the cellulase acts to render the surface of a fabric more hydrophilic to allow water to wet its surface. Counter-intuitively, in the present invention cellulase enzymes are employed to promote the deposition of fragrance ingredients, which are generally lipophilic materials, onto the surface of a textile.

Enzymes useful in exercise of the present invention are cellulase enzymes, in particular family GH45 cellulases. It has not previously been shown that using a cellulase, such as a family GH45 cellulase, in softeners can improve deposition of fragrance onto a textile. As can be seen in the examples of the present invention, deposition of fragrance is improved when a cellulase has been added to the softener.

In one embodiment, the enzyme is a cellulase having at least 60% sequence identity to SEQ ID NO: 1, SEQ ID NO: 2, SEQ ID NO: 3, SEQ ID NO: 4, SEQ ID NO: 5, SEQ ID NO: 6, SEQ ID NO: 7, or SEQ ID NO: 8.

The cellulase may be anyone having at least 60% sequence identity to SEQ ID NO: 1, SEQ ID NO: 2, SEQ ID NO: 3, SEQ ID NO: 4, SEQ ID NO: 5, SEQ ID NO: 6, SEQ ID NO: 7, or SEQ ID NO: 8, preferably the cellulase has at least 65%, such as 70%, such as 75%, such as 80%, such as 85%, such as 90%, such as 91%, such as 92%, such as 93%, such as 94%, such as 95%, such as 96%, such as 97%, such as 98%, such as 99%, or such as 100%, sequence identity to SEQ ID NO: 1, SEQ ID NO: 2, SEQ ID NO: 3, SEQ ID NO: 4, SEQ ID NO: 5, SEQ ID NO: 6, SEQ ID NO: 7, or SEQ ID NO: 8, or a fragment of SEQ ID NO: 1, SEQ ID NO: 2, SEQ ID NO: 3, SEQ ID NO: 4, SEQ ID NO: 5, SEQ ID NO: 6, SEQ ID NO: 7, or SEQ ID NO: 8 having cellulase activity.

Further suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and WO 89/09259.

Additional suitable cellulases are the alkaline or neutral cellulases having colour care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. Nos. 5,457,046, 5,686,593, 5,763,254, WO 95/24471, WO 98/12307 and W099/001544.

Other cellulases are endo-beta-1,4-glucanase enzyme having a sequence of at least 97% identity to the amino acid sequence of position 1 to position 773 of SEQ ID NO:2 of WO 2002/099091 or a family 44 xyloglucanase, which a xyloglucanase enzyme having a sequence of at least 60% identity to positions 40-559 of SEQ ID NO: 2 of WO 2001/062903.

Commercially available cellulases include Celluzyme, Carezyme, Carezyme Premium, Celluclean, Celluclean Classic, Cellusoft, Whitezyme, Celluclean 4500T and Celluclean 5000L (all registered trademarks of Novozymes A/S), Clazinase and Puradax HA (registered trademarks of Genencor International Inc.), KAC-500(B) (registered trademark of Kao Corporation), Revitalenz 200 and Revitalenz 2000 (registered trademarks of Danisco/Dupont), and Biotouch FLX1, Biotouch FCL75, Biotouch DCL and Biotouch FCC45 (registered trademarks of AB Enzymes).

In particular embodiments of the present invention, the amount of cellulase enzyme that is effective in improving the deposition of fragrance on treated, e.g. laundered, textiles is in the range of 0.05 wt % to 2 wt % based on the total weight of the fabric conditioner, such as in the range of 0.1 wt % to 1.5 wt %, 0.1 wt % to 1 wt %, 0.1 wt % to 0.5 wt %, based on the total weight of the fabric conditioner.

In another embodiment of the present invention, the amount of cellulase that is effective in improving the deposition of fragrance on treated, e.g. laundered, textiles is in the range of 0.5 wt % to 25 wt % based on the dry matter weight of the fabric conditioner, such as in the range of 1 wt % to 20 wt %, 1 wt % to 15 wt %, 1 wt % to 5 wt % based on the dry matter weight of the fabric conditioner.

The fabric conditioner composition can comprise from about from about 0.5% to about 40% by weigh of a cationic surfactant, for example from about 0.5% to about 30%, in particular from about 1% to about 20%, from about 3% to about 10%, such as from about 3% to about 5%, from about 8% to about 12% or from about 8% to about 10%. Non-limiting examples of cationic surfactants include bis(acyloxyethyl)hydroxyethyl methylammonium methosulphate, dipalmoylethyl hydroxyethylmonium methosulfate, dihydrogenated tallow hydroxyethylmonium methosulfate, distearoylethyl hydroxyethylmonium methosulfate, dioleoyl ethyl hydroxyethylmonium methosulfate alkyl quaternary ammonium compounds, alkoxylated quaternary ammonium (AQA) compounds, other ester quats, and combinations thereof.

Typical cationic surfactants include but are not limited to quaternary ammonium salts having one or two alkyl chain comprising 10 to 22 carbon atoms, and optionally hydroxyl groups, and two to three alkyl groups having 1 to 4 carbon or hydroxyalkyl or hydroxyl groups, or alkoxy groups, having typically about 1 to about 10 ethylene oxide moieties, and an anion selected from the group of halides, hydroxides, acetates and methylsulfate, such as ditallowalkyldimethyl (or diethyl or dihydroxyethyl) ammonium chloride, ditallowalkyldimethylammonium methyl sulfate, methyl tallowalkyl amido ethyl, ditallowalkyldimethylammonium methyl sulfate, dihexadecylalkyl dimethyl (or diethyl, or dihydroxyethyl) ammonium chloride, dioctadecyl- alkyl dimethylammonium chloride, such as DODMAC (dioctadecyl dimethyl ammonium chloride), and dieicosylalkyl dimethylammonium chloride, ethyl-tallowalkyl imidazolinium methyl sulphate, ditallowalkyldimethylammonium methyl sulfate, methyl tallowalkyl amido ethyl tallowalkyl imidazolinium methyl sulfate, quaternary ammonium salts having one or two acyloxy-alkyl chains, one or two alkyl groups and/or one or two hydroxyalkyl groups, such as so-called esterquat (N-methyl-N,N,bis[2-(C16-C18-acetoxy)ethyl)]-N-(2-hydroxyethyl) ammonium methosulfate), diesterquat (N,N,N-trimethyl-N-[1,2-di-(C16-C18-acyloxy)propyl ammonium salts), DEEDMAC (N,N-dimethyl-N,N-bis([2-(-[(1-oxooctadecyl)oxy]ethyl) ammonium chloride, HEQ (N,N,N-trimethyl-N-[(Z)-2-hydroxy-3-[(1-oxo-octadec-9-enyl)oxy]] ammonium chloride, TEAQ (diquaternized methylsulfate salt of the reaction product between C10-C20 staturated and unsaturated fatty acids and triethanoloamine), alkylbenzyl dialkyl ammonium chloride, whereas the anion is selected from halides (such as chloride or bromide), hydroxy, ethylsulfate, acetate, carbonate, nitrate, phosphate and methylcarbonate.

A fabric conditioner composition can contain small amounts of non-ionic surfactants, such as for example about 0.1% to about 10% by weight. Non-limiting examples of nonionic surfactants include polysorbates, polyethylene glycol ethers, Polyoxyethylene alkyl ethers, alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), as well as products available under the trade names SPAN and TWEEN, and combinations thereof.

The fabric conditioner compositions may comprise about 0-10% by weight, such as about 0.1% to about 5% of a builder or co-builder, or a mixture thereof. The level of builder is typically 0-1%, particularly 0-0.5%. The builder and/or co-builder may particularly be a chelating agent that forms water-soluble complexes with Ca and Mg ions. Any builder and/or co-builder known in the art for use in fabric conditioner compositions may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan-1-ol (MEA), diethanolamine (DEA, also known as 2,2′-iminodiethan-1-ol), triethanolamine (TEA, also known as 2,2′,2″-nitrilotriethan-1-ol), and (carboxymethyl)inulin (CMI), and combinations thereof.

The fabric conditioner composition may also comprise 0 to 5 wt %, more particularly about 0 wt % to about 2 wt %, of a detergent co-builder. The detergent composition may include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diphosphonic acid (HEDP), ethylenediaminetetra(methylenephosphonic acid) (EDTM PA), diethylenetriaminepentakis(methylenephosphonic acid) (DTM PA or DTPM PA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)-aspartic acid (SMAS), N-(2-sulfoethyl)-aspartic acid (SEAS), N-(2-sulfomethyl)-glutamic acid (SMGL), N-(2-sulfoethyl)-glutamic acid (SEGL), N-methyliminodiacetic acid (MIDA), Δ-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA), N-(2-hydroxyethyl)ethylenediamine-N,N′,N″-triacetic acid (HEDTA), diethanolglycine (DEG), diethylenetriamine penta(methylenephosphonic acid) (DTPMP), aminotris(methylenephosphonic acid) (ATMP), and combinations and salts thereof. Further exemplary builders and/or co-builders are described in, e.g., WO 09/102854, U.S. Pat. No. 5,977,053

### Polymers

The fabric conditioner composition may comprise 0 to 10 wt %, more particularly 0.2 to 5 wt %, still more particularly 0.2 to 5 wt %, more particularly still 0.2 to 2 wt %, and still more particularly 0.2 to 1 wt % of a polymer. Any polymer known in the art for use in fabric conditioner compositions may be utilized. The polymer may function as a co-builder as mentioned above, or may provide anti-redeposition, fiber protection, soil release, dye transfer inhibition, anti-foaming properties, perfume encapsulation and lubricity. Some polymers may have more than one of the above-mentioned properties and/or more than one of the below-mentioned motifs. Exemplary polymers include polyquaterniums, melamine polymers, siloxanes, silicones, carboxymethyl)cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA/PMA, poly-aspartic acid, and lauryl methacrylate/acrylic acid copolymers, hydrophobically modified CMC (HM-CMC), copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI).

Further exemplary polymers include sulfonated polycarboxylates, polyethylene oxide and polypropylene oxide (PEO-PPO) and diquaternium ethoxy sulfate. Other exemplary polymers are disclosed in, e.g., WO 2006/130575. Salts of the above-mentioned polymers are also contemplated.

Fabric conditioner compositions may contain adjunct materials. These optional ingredients include solvents (including isopropyl alcohol, propylene glycol, alkane/cycloalkane), anti-shrink agents, anti-soil redeposition agents, anti-wrinkling agents, bactericides, preservatives (including benzisothiazolinone, methylisothiazolinone and/or lactic acid), binders, dyes, enzyme stabilizers (including boric acid, borates, CMC, and/or polyols such as propylene glycol), emulsion stabilizers, antifoam agents (including dimethicone), skin conditioning agents (including caprylic/capric glycerides, ethylhexyl stearate, or cocos oil, either alone or in combination. The choice of such ingredients is well within the skill of the artisan.

A fabric conditioner composition is typically applied to laundry during the rinse-cycle in a washing machine.

The fabric conditioner composition of the present invention comprises a perfume oil. The perfume oil may be present at any suitable level, preferably at a relatively high level, e.g., above 1% by weight of the fabric conditioner composition. Typically, the level of perfume oil in a fabric conditioner composition is from 0.05 to 2.5 wt %, more particularly from 0.1 to 1.5 wt.-%, still more particularly from 0.2 to 1 wt.-%.

A perfume oil is typically a mixture of relatively polar and relatively non-polar oils. One generally predicative measure of a perfume oil's dispersibility in aqueous compositions comprising high levels of cationic surfactant is the perfume ingredient's Log P that is the ingredient's partition coefficient between water and octanol. LogP can be measured or calculated. Preferably the calculated value is used. A very common way of calculating the logP of a perfume ingredient is using a “ClogP” program from Daylight Chemical Information Systems, Inc. of Aliso Viejo, CA, USA (latest version). A perfume ingredient having a high CLogP will tend to require more energy to disperse within a fabric conditioner composition, however it will be more likely to deposit onto a hydrophobic substrate.

Perfume ingredients having too high ClogP values may however have a too low vapor pressure or be incompatible with other softener ingredients. Typically, suitable perfume ingredients have a ClogP lower than 7, more particularly lower than 6.5.

Generally speaking a fragrance for use in a fabric conditioner composition according to the present invention will contain more than 25 wt %, still more particularly more than 35 wt %, still more particularly more than 45 wt %, still more particularly more than 50, 60, 70 or 75 wt % of perfume ingredients, having a Clog P higher than 2.5 and lower than 7, more particularly lower than 6.

In an embodiment of the invention, the perfume oil comprises a perfume ingredient selected from the group consisting of (2-(1-propoxyethoxy)ethyl)benzene (ACETAL R, ClogP=3.03); hexyl acetate (ACETATE C 6 HEXYLIC, ClogP=2.83); 2,6,10-trimethylundec-9-enal (ADOXAL, ClogP=5.38); 2-(tert-butyl)cyclohexyl acetate (AGRUMEX, ClogP=4.06); decanal (ALDEHYDE C 10 DECYLIC, ClogP=4.01); 2-methyldecanal (ALDEHYDE C 11 MOA, ClogP=4.54); undec-10-enal (ALDEHYDE C 11 UNDECYLENIC, ClogP=4.05); 10-undecenal (ALDEHYDE C 110 UNDECYLIC, ClogP=4.54); dodecanal (ALDEHYDE C 12 LAURIC, ClogP=5.07); 2-methylundecanal (ALDEHYDE C 12 MNA PURE, ClogP=5.07); octanal (ClogP=2.95); nonanal (ClogP=3.48); (E)-undec-9-enal (ALDEHYDE ISO C 11, ClogP=4.05); prop-2-enyl 2-(3-methylbutoxy)acetate (ALLYL AMYL GLYCOLATE, ClogP=2.58); prop-2-enyl hexanoate (ClogP=3.07); prop-2-enyl 3-cyclohexylpropanoate (ALLYL CYCLOHEXYL PROPIONATE, ClogP=4.14); prop-2-enyl heptanoate (ALLYL OENANTHATE, ClogP=3.6); 1-((2-(tert-butyl)cyclohexyl)oxy)butan-2-ol (AMBER CORE, ClogP=3.97); 1,3,4,5,6,7-hexahydro-beta.,1,1,5,5-pentamethyl-2H-2,4a-Methanonaphthalene-8-ethanol (AMBERMAX 10%/TEC, Clog P=6.37); (Z)-oxacycloheptadec-10-en-2-one (AM BRETTOLI DE, ClogP=5.42); (4aR,5R,7aS,9R)-Octahydro-2,2,5,8,8,9a-hexamethyl-4H-4a,9-methanoazuleno[5,6-d]-1,3-dioxole (AMBROCENIDE 10%/DPG, ClogP=5.64); (3aR,5aS,9aS,9bR)-3a,6,6,9a-tetramethyl-2,4,5,5a,7,8,9,9b-octahydro-1H-benzo[e][1]-benzofuran (AMBROFIX, ClogP=5.47); pentyl 2-hydroxybenzoate (AMYL SALICYLATE, ClogP=4.45); (E)-methyl 2-((7-hydroxy-3,7-dimethyloctylidene)amino)benzoate (AURANTIOL PURE, ClogP=4.22); benzyl benzoate (ClogP=3.94); benzyl 2-hydroxybenzoate (BENZYL SALICYLATE, ClogP=4.16); (ethoxymethoxy)cyclododecane (BOISAMBRENE FORTE, ClogP=5.48); (2S,4S)-1,7,7-trimethylbicyclo[2.2.1]heptan-2-yl acetate (BORNYL ACETATE LIQUID, ClogP=4.05); 4-(tert-butyl)cyclohexyl acetate (BUTYL CYCLOHEXYL ACETATE PARA, ClogP=4.06); 1,1,2,3,3-pentamethyl-2,3,6,7-tetrahydro-1H-inden-4(5H)-one (CASHMERAN, ClogP=4); (E)-3,7-dimethylocta-2,6-dienal (CITRAL, ClogP=2.95); (Z)-1,1-diethoxy-3,7-dimethylocta-2,6-diene (CITRATHAL R, ClogP=4.34); 3,7-dimethyloct-6-en-1-ol (CITRONELLOL, ClogP=3.25); 3,7-dimethyloct-6-en-1-yl acetate (CITRONELLYL ACETATE, ClogP=4.2); 3,7-dimethyloct-6-enenitrile (CITRONELLYL NITRILE, ClogP=3.09); 3,7-dimethyloct-6-en-1-yl propanoate (CITRONELLYL PROPIONATE, ClogP=4.73); (Z)-3-methylcyclotetradec-5-enone (COSMONE, ClogP=5.37); (4-methylphenyl) 2-phenylacetate (CRESYL PHENYL ACETATE PARA, ClogP=3.84); 3-(4-isopropylphenyl)-2-methylpropanal (CYCLAMEN ALDEHYDE, ClogP=3.83); allyl 2-(cyclohexyloxy)acetate (CYCLOGALBANATE, ClogP=2.62); 1-oxacycloheptadecan-2-one (CYCLOHEXADECANOLIDE, ClogP=7.61); 2-cyclohexylethyl acetate (CYCLOHEXYL ETHYL ACETATE, ClogP=3.36); cyclohexyl 2-hydroxybenzoate (CYCLOHEXYL SALICYLATE, ClogP=4.37); cyclopentadecanone (CYCLOPENTADECANONE, ClogP=5.9); 1-methyl-4-propan-2-ylbenzene (CYMENE PARA, ClogP=4.07); (E)-1-(2,6,6-trimethylcyclohexa-1,3-dien-1-yl)but-2-en-1-one (DAMASCENONE, ClogP=4.27); (E)-1-(2,6,6-trimethylcyclohex-2-en-1-yl)but-2-en-1-one (DAMASCONE ALPHA, ClogP=3.82); 1-(2,6,6-trimethyl-1-cyclohex-3-enyl)but-2-en-1-one (DAMASCONE DELTA, ClogP=3.62); (E)-dec-4-enal (DECENAL-4-TRANS, ClogP=3.52); 2,6-dimethyloct-7-en-2-ol (DIHYDRO MYRCENOL, ClogP=3.03); methyl 2-(methylamino)benzoate (DIMETHYL ANTHRANILATE, ClogP=2.66); 2-methyl-1-phenylpropan-2-yl acetate (DIMETHYL BENZYL CARBINYL ACETATE, ClogP=2.99); 2-methyl-1-phenylpropan-2-yl butanoate (DIMETHYL BENZYL CARBINYL BUTYRATE, ClogP=4.05); 2,6-dimethylheptan-2-ol (DIMETOL, ClogP=2.99); 1-methyl-4-(prop-1-en-2-yl)cyclohex-1-ene (DIPENTENE, LIMONENE, ClogP=4.35); oxydibenzene (DIPHENYL OXIDE, ClogP=4.24); 5-octyloxolan-2-one (DODECALACTONE GAMMA, ClogP=3.42); (E)-dodec-2-enal (DODECENAL, ClogP=4.75); (E)-4-((3aS,7aS)-hexahydro-1H-4,7-methanoinden-5(6H)-ylidene)butanal (DUPICAL, ClogP=4.15); (E)-3-methyl-5-(2,2,3-trimethylcyclopent-3-en-1-yl)pent-4-en-2-ol (EBANOL, ClogP=4.21); ethyl benzoate (ETHYL BENZOATE, ClogP=2.64); ethyl hexanoate (ETHYL CAPROATE, ClogP=2.83); ethyl octanoate (ETHYL CAPRYLATE, ClogP=3.89); (E)-3,7-dimethylnona-1,6-dien-3-ol (ETHYL LINALOOL, ClogP=3.28); (Z)-3,7-dimethylnona-1,6-dien-3-yl acetate (ETHYL LINALYL ACETATE, ClogP=4.22); ethyl heptanoate (ETHYL OENANTHATE, ClogP=3.36); ethyl 2,6,6-trimethylcyclohexa-1,3-diene-1-carboxylate (ETHYL SAFRANATE, ClogP=3.96); 1,4-dioxacycloheptadecane-5,17-dione (ETHYLENE BRASSYLATE, ClogP=3.02); (1s,4s)-1,3,3-trimethyl-2-oxabicyclo[2.2.2]octane (EUCALYPTOL, ClogP=2.83); methyl 2,4-dihydroxy-3,6-dimethylbenzoate (EVERNYL, ClogP=2.73); 1-(3,5,5,6,8,8-hexamethyl-5,6,7,8-tetrahydro-naphthalen-2-yl)ethanone (FIXOLIDE, ClogP=6.25); 3-(4-ethylphenyl)-2,2-dimethylpropanal (FLORALOZONE, ClogP=3.83); 3-(3-isopropylphenyl)butanal (FLORHYDRAL, ClogP=3.7); (E)-undec-9-enenitrile (FLORIDILE, ClogP=3.88); (3aR,6S,7aS)-3a,4,5,6,7,7a-hexahydro-1H-4,7-methanoinden-6-yl propanoate (FLOROCYCLENE, ClogP=3.41); 2,4,6-trimethyl-4-phenyl-1,3-dioxane (FLOROPAL, ClogP=2.79); methyl oct-2-ynoate (FOLIONE, ClogP=2.72); 2-(sec-butyl)cyclohexanone (FRESKOMENTHE, ClogP=2.84); (3aS,4S,7R,7aS)-ethyl octahydro-1H-4,7-methanoindene-3a-carboxylate (FRUITATE, ClogP=3.37); 2-methyldecanenitrile (FRUTONILE, ClogP=4.15); 4,6,6,7,8,8-hexamethyl-1,3,4,6,7,8-hexahydrocyclopenta[g]isochromene (GALAXOLI DE, ClogP=5.74); 1-(5,5-dimethylcyclohex-1-en-1-yl)pent-4-en-1-one (GALBANONE, ClogP=3.63); (3aR,6S,7aS)-3a,4,5,6,7,7a-hexahydro-1H-4,7-methanoinden-6-yl 2-methyl propanoate (GARDOCYCLENE, ClogP=3.71); 1-(1,2,8,8-tetramethyl-1,2,3,4,5,6,7,8-octahydronaphthalen-2-yl)ethanone (GEORGYWOOD, ClogP=4.85); (E)-3,7-dimethylocta-2,6-dien-1-ol (GERANIOL 980, ClogP=2.97); (E)-3,7-dimethylocta-2,6-dien-1-yl acetate (GERANYL ACETATE SYNTHETIC, ClogP=3.92); ethyl 2-ethyl-6,6-dimethylcyclohex-2-enecarboxylate (GIVESCONE, ClogP=4.54); (E)-oxacyclohexadec-12-en-2-one (HABANOLIDE, ClogP=4.86); methyl 3-oxo-2-pentylcyclopentaneacetate (HEDIONE, ClogP=2.91); (2S)-ethyl 3-isopropylbicyclo[2.2.1]hept-5-ene-2-carboxylate (HERBANATE, ClogP=3.98); (3R,5R)-3-ethoxy-1,1,5-trimethylcyclohexane (HERBAVERT, ClogP=3.93); methyl 7-isopropyl-1,4a-dimethyl-1,2,3,4,4a,4b,5,6,7,8,10,10a-dodecahydrophenanthrene-1-carboxylate (HERCOLYN DW, ClogP=7.08); (Z)-hex-3-en-1-yl 2-hydroxybenzoate (HEXENYL-3-CIS SALICYLATE, ClogP=4.5); (E)-2-benzylideneoctanal (HEXYL CINNAMIC ALDEHYDE, ClogP=5); hexyl 2-hydroxybenzoate (HEXYL SALICYLATE, ClogP=4.98); 8,8-di(1H-indo1-3-yl)-2,6-dimethyloctan-2-ol (INDOLENE, ClogP=6.35); (E)-4-(2,6,6-trimethylcyclohex-1-en-1-yl)but-3-en-2-one (IONONE BETA, ClogP=3.77); (E)-4-(2,6,6-trimethylcyclohex-2-en-1-yl)but-3-en-2-one (IRISONE PURE, ClogP=3.71); (E)-4-(2,5,6,6-tetramethylcyclohex-2-en-1-yl)but-3-en-2-one (IRONE ALPHA, ClogP=4.23); 142,3,8,8-tetramethyl-1,2,3,4,5,6,7,8-octahydronaphthalen-2-Aethanone (ISO E SUPER, ClogP=4.85); 6-butan-2-yl-quinoline (ISOBUTYL QUINOLINE-2, ClogP=3.98); (E)-2-methoxy-4-(prop-1-en-1-yl)phenol (ISOEUGENOL, ClogP=2.58); (E)-3-methyl-4-(2,6,6-trimethylcyclohex-2-en-1-yl)but-3-en-2-one (ISORALDEINE 70, ClogP=4.02); (3aR,6S,7aS)-3a,4,5,6,7,7a-hexahydro-1H-4,7-methanoinden-6-yl acetate (JASMACYCLENE, ClogP=2.88); 2-hexylcyclopentanone (JASMATONE, ClogP=3.47); (Z)-3-methyl-2-(pent-2-en-1-yl)cyclopent-2-enone (JASMONE CIS, ClogP=2.64); (1-methyl-2-(1,2,2-trimethylbicyclo[3.1.0]hexan-3-yl)methyl)cyclopropyl)methanol (JAVANOL, ClogP=4.65); (Z)-3,4,5,6,6-pentamethylhept-3-en-2-one (KOAVONE, ClogP=3.48); (3E,6E)-2,4,4,7-tetramethylnona-6,8-dien-3-one oxime (LABIENOXIME, ClogP=3.8); (2E,6Z)-3,7-dimethylnona-2,6-dienenitrile (LEMONILE, ClogP=3.78); (E)-methyl 2-(((2,4-dimethylcyclohex-3-en-1-yl)methylene)amino)benzoate (LIGANTRAAL, ClogP=5.03); 3-(4-(tert-butyl)phenyl)-2-methylpropanal (LILIAL, ClogP=4.23); 3,7-dimethylocta-1,6-dien-3-ol (LINALOOL, ClogP=2.75); 3,7-dimethylocta-1,6-dien-3-yl acetate (LINALYL ACETATE, ClogP=3.69); ethyl 2-methylpentanoate (MANZANATE, ClogP=2.61); 3-methyl-5-phenylpentan-1-ol (MEFROSOL, ClogP=3.17); 2,6-dimethylhept-5-enal (MELONAL, ClogP=2.87); 2-isopropyl-5-methylcyclohexanol (MENTHOL NATURAL, ClogP=3.23); 2-isopropyl-5-methylcyclohexanone (MENTHONE, ClogP=2.83); 2-(4-methylcyclohex-3-en-1-yl)propane-2-thiol (MERCAPTO-8 MENTHENE-1 PARA, ClogP=4.04); 1-((1S,8aS)-1,4,4,6-tetramethyl-2,3,3a,4,5,8-hexahydro-1H-5,8a-methanoazulen-7-yl)ethanone (METHYL CEDRYL KETONE, ClogP=5.53); (E)-1,2-dimethoxy-4-(prop-1-en-1-yl)benzene (METHYL ISOEUGENOL, ClogP=3.05); undecan-2-one (METHYL NONYL KETONE EXTRA, ClogP=4.02); methyl non-2-ynoate (METHYL OCTYNE CARBONATE, ClogP=3.25); 6,6-dimethoxy-2,5,5-trimethylhex-2-ene (METHYL PAMPLEMOUSSE, ClogP=2.98); (Z)-3-methylcyclopentadec-5-enone (MUSCENONE, ClogP=5.93); 7-methyl-3-methyleneocta-1,6-diene (MYRCENE, ClogP=4.33); 2-methylundecanoic acid (MYSTIKAL, ClogP=4.88); 2-(2-(4-methylcyclohex-3-en-1-yl)propyl)cyclopentan-1-one (NECTARYL, ClogP=4.44); 2-methyl-6-methyleneoct-7-en-2-yl acetate (NEOBERGAMATE FORTE, ClogP=3.56); 10-isopropyl-2,7-dimethyl-1-oxaspiro[4.5]deca-3,6-diene (NEOCASPIRENE EXTRA, ClogP=4.96); (E)-methyl non-2-enoate (NEOFOLIONE, ClogP=3.97); (E)-3,7,11-trimethyldodeca-1,6,10-trien-3-ol (NEROLIDOL SYNTHETIC, ClogP=4.78); 2-ethoxynaphthalene (NEROLINE CRYSTALS, ClogP=3.76); 1-(3-methylbenzofuran-2-yl)ethanone (NEROLIONE, ClogP=2.64); (Z)-3,7-dimethylocta-2,6-dien-1-yl acetate (NERYL ACETATE HC, ClogP=3.92); (2E,6Z)-nona-2,6-dienal (NONADIENAL, ClogP=2.68); (2Z,6E)-2,6-nonadien-1-ol (NONADIENOL-2,6, ClogP=2.7); (Z)-non-6-enal (NONENAL-6-CIS, ClogP=2.99); (Z)-non-6-en-1-ol (NONENOL-6-CIS, ClogP=2.98); 3-(4-(2-methylpropyl)-2-methylphenyl)propanal (NYMPHEAL, ClogP=3.7); (E)-3,7-dimethylocta-1,3,6-triene (OCIMENE, Clog P=4.33); 1-(2-naphtalenyl)-ethanone (ORANGER CRYSTALS, ClogP=2.76); 2,4a,5,8a-tetramethyl-1,2,3,4,4a,7,8,8a-octahydronaphthalen-1-yl formate (OXYOCTALINE FORMATE, ClogP=4.79); 2-ethyl-N-methyl-N-(m-tolyl)butanamide (PARADISAMIDE, ClogP=3.5); 5-heptyldihydrofuran-2(3H)-one (PEACH PURE, ClogP=2.89); 2-methyl-4-methylene-6-phenyltetrahydro-2H-pyran (PELARGENE, ClogP=3.07); 3,7-dimethyloctan-1-ol (PELARGOL, ClogP=3.74); 2-cyclohexylidene-2-phenylacetonitrile (PEONILE, ClogP=3.86); 2-cyclohexylidene-2-(o-tolyl)acetonitrile (PETALIA, ClogP=4.36); 2-cyclohexylidene-2-(o-tolyl)acetonitrile (PETALIA, ClogP=4.36); 2-cyclohexylhepta-1,6-dien-3-one (PHARAONE, ClogP=3.52); 2-(phenoxy)ethyl 2-methylpropanoate (PHENOXY ETHYL ISOBUTYRATE, ClogP=2.92); 2-phenylethyl 2-methylpropanoate (PHENYL ETHYL ISOBUTYRATE, ClogP=3.12); 2-phenylethyl 2-phenylacetate (PHENYL ETHYL PHENYL ACETATE, ClogP=3.92); 2,6,6-trimethylbicyclo[3.1.1]hept-2-ene (PINENE ALPHA, ClogP=4.7); 6,6-dimethyl-2-methylenebicyclo[3.1.1]heptane (PINENE BETA, ClogP=4.7); 2,2-dimethyl-2-pheylethyl propanoate (PIVAROSE, ClogP=3.52); (2E,5E)-5,6,7-trimethylocta-2,5-dien-4-one (POMAROSE, ClogP=3.8); 1-methyl-4-(4-methylpent-3-en-1-yl)cyclohex-3-ene-carbaldehyde (PRECYCLEMONE B, ClogP=4.39); 6-(sec-butyl)quinoline (PYRALONE, ClogP=3.98); 2-pentylcyclopentanone (QUINTONE, ClogP=2.94); (E)-2-ethyl-4-(2,2,3-trimethylcyclopent-3-en-1-yl)but-2-en-1-ol (RADJANOL, ClogP=4.63); 2,4-dimethyl-4-phenyltetrahydrofuran (RHUBAFURAN, ClogP=3.12); (4aR,8aS,E)-6-ethylideneoctahydro-2H-5,8-methanochromene (RHUBOFLOR, ClogP=3.23); 2,2,2-trichloro-1-phenylethyl acetate (ROSACETOL, ClogP=4.05); dec-9-en-1-ol (ROSALVA, ClogP=3.51); 4-methyl-2-(2-methylprop-1-en-1-yl)tetrahydro-2H-pyran (ROSE OXIDE CO, ClogP=3.17); 3-(2-methylpropyl)-1-methylcyclohexanol (ROSSITOL, ClogP=3.76); 2,3,3-trimethyl-1-indanone (SAFRALEINE, ClogP=3.27); 3-methyl-5-(2,2,3-trimethylcyclopent-3-en-1-yl)pentan-2-ol (SANDALORE EXTRA, ClogP=4.69); 3-((1R,2S,4R,6R)-5,5,6-trimethylbicyclo[2.2.1]heptan-2-yl)cyclohexanol (SANDELA, ClogP=5.65); ethyl N,S-bis(4-oxo-4-(2,6,6-trimethylcyclohex-3-en-1-yl)butan-2-yl)cysteinate (SCENTAURUS BERRY, ClogP=7.47); ethyl (Z)-2-acetyl-4-methyltridec-2-enoate (SCENTAURUS CLEAN, ClogP=6.64); 4-(dodecylthio)-4-methylpentan-2-one (SCENTAURUS JUICY, ClogP=7.15); 2-(1-(3,3-dimethylcyclohexyl)ethoxy)-2-methylpropyl cyclopropanecarboxylate (SERENOLIDE, ClogP=5.44); 2-methyl-3-[4-(2-methylpropyl)phenyl]propanal (SILVIAL, ClogP=4.36); 1-(spiro[4.5]dec-6-en-7-yl)pent-4-en-1-one (SPIROGALBANONE PURE, ClogP=4.02); (E)-5-methylheptan-3-one oxime (STEMONE, ClogP=2.64); ethyl methyl phenyl glycidate (STRAWBERRY PURE, ClogP=2.95); (E)-6-ethyl-3-methyloct-6-en-1-ol (SUPER MUGUET, Clog P=3.78); (E)-2-((3,5-dimethylhex-3-en-2-yl)oxy)-2-methylpropyl cyclopropanecarboxylate (SYLKOLIDE, ClogP=4.38); 1-methyl-4-propan-2-ylcyclohexa-1,4-diene (TERPINENE GAMMA, ClogP=4.35); 2-(4-methylcyclohex-3-en-1-yl)propan-2-ol (TERPINEOL PURE, ClogP=2.63); 1-methyl-4-(propan-2-ylidene)cyclohex-1-ene (TERPINOLENE, ClogP=4.35); 2-(4-methyl-1-cyclohex-3-enyl)propan-2-yl acetate (TERPINYL ACETATE, ClogP=3.58); 3,7-dimethyloctan-3-ol (TETRAHYDRO LINALOOL, ClogP=3.52); 2,6-dimethyloctan-2-ol (TETRAHYDRO MYRCENOL, ClogP=3.52); oxacyclohexadecan-2-one (THI BETOLI DE, ClogP=5.35); 2,2,6-trimethylcyclohexyl-3-hexanol (TIMBEROL, ClogP=5.87); 1-(cyclopropylmethyl)-4-methoxybenzene (TOSCANOL, ClogP=3.53); (E)-tridec-2-enenitrile (TRIDECENE-2-NITRILE, ClogP=5.58); (E)-4-methyldec-3-en-5-ol (UNDECAVERTOL, ClogP=3.89); (E)-methyl 2-((3-(4-(tert-butyl)phenyl)-2-methylprop-1-en-1-yl)amino)benzoate (VERDANTIOL, ClogP=8.01); 1-((1S,8aS)-1,4,4,6-tetramethyl-2,3,3a,4,5,8-hexahydro-1H-5,8a-methanoazulen-7-yl)ethanone (VERTOFIX COEUR, ClogP=5.53); (4,8-dimethyl-2-propan-2-ylidene-3,3a,4,5,6,8a-hexahydro-1H-azulen-6-yl) acetate (VETYVENYL ACETATE, ClogP=5.36); (2E,6Z)-nona-2,6-dienenitrile (VIOLET NITRILE, ClogP=2.98); undec-10-enenitrile (VIOLIFF, ClogP=2.77); 2-methoxynaphtalene (YARA YARA, ClogP=3.23); and a combination thereof. Most preferably, the perfume oil comprises delta-damascone.

A proportion of the perfume oil employed in the fabric conditioner composition according to the invention may be encapsulated. Any of the perfume encapsulates described in the prior art may be employed in the present invention. Non-limiting examples of perfume encapsulates are disclosed in the following prior art references: US 2003/215417; US 2003/216488; US 2003/158344; US 2003/165692; US 2004/071742; US 2004/071746; US 2004/072719; US 2004/072720; EP 1,393,706; US 2003/203829; US 2003/195133; US 2004/087477; US 2004/0106536; US 6,645,479; and US 6,200,949.

Perfume encapsulates may be prepared using a range of conventional methods known to those skilled in the art for making shell capsules, such as Interfacial polymerization, and polycondensation. Non-limiting examples of materials suitable for making shell of the microcapsule include urea-formaldehyde, melamine-formaldehyde, phenol-formaldehyde, gelatin, polyurethane, polyamides and the like.

### EMBODIMENTS OF THE INVENTION

The invention is further outlined in the following embodiments consecutively numbered starting with embodiment 1 (E1):

E1 The use of an enzyme having cellulase activity in a consumer product composition, and more particularly a fabric conditioner composition or a scent booster composition for improving deposition of a fragrance onto a textile.
E2 The use according to E1 wherein the enzyme having cellulase activity is selected from glycoside hydrolase family 5 (GH5), glycoside hydrolase family 7 (GH7), glycoside hydrolase family 12 (GH12), glycoside hydrolase family 44 (GH44) and glycoside hydrolase family 45 (GH45).
E3 The use according to E1 or E2, wherein the cellulase has endoglucanase activity
E4 The use according to any of the preceding embodiments, wherein the cellulase has at least 60% sequence identity to any of SEQ ID NO:1, SEQ ID NO:2, SEQ ID NO:3, SEQ ID NO:4 SEQ ID NO: 5, SEQ ID NO: 6, SEQ ID NO: 7, or SEQ ID NO: 8.
E5 The use according to any of the preceding embodiments, wherein the cellulase has at least 70%, such as 80%, such as 80%, such as 80%, such as 80% such as 80% such as 80% such as 85% such as 90% such as 95% such as 96% such as 97% such as 98%, such as 99% sequence identity to any of SEQ ID NO:1, SEQ ID NO:2, SEQ ID NO:3, SEQ ID NO:4, SEQ ID NO: 5, SEQ ID NO: 6, SEQ ID NO: 7, or SEQ ID NO: 8.
E6 The use according to any of the preceding embodiments, wherein the cellulase has 100% sequence identity to SEQ ID NO:1, SEQ ID NO:2, SEQ ID NO:3, SEQ ID NO:4, SEQ ID NO: 5, SEQ ID NO: 6, SEQ ID NO: 7, or SEQ ID NO: 8.
E7 The use according to any of the preceding embodiments wherein the cellulase is present in an amount of 0.05 wt % to 2 wt % based on the total weight of the fabric conditioning composition.
E8 The use according to any of the preceding embodiments wherein the cellulase is present in an amount in of range of 0.1 wt % to 1.5 wt %, 0.1 wt % to 1 wt %, 0.1 wt % to 0.5 wt %, based on the total weight of the fabric conditioner.
E9 The use according to any of the preceding embodiments wherein the cellulase is present in an amount in the range of 0.5 wt % to 25 wt % based on the dry matter weight of the fabric conditioner, such as in the range of 1 wt % to 20 wt %, 1 wt % to 15 wt %, 1 wt % to 5 wt %, based on the dry matter weight of the fabric conditioner.
E10 The use according to any of the preceding embodiments, wherein the fabric conditioner composition comprises a cationic surfactant in an amount of 0.5 wt % to 40 wt % based on the total weight of the fabric conditioner composition.
E11 The use according to any of the preceding embodiments, wherein the fabric conditioner composition comprises a cationic surfactant in an amount of 0.5% to about 30%, in particular from about 1% to about 20%, from about 3% to about 10%, such as from about 3% to about 5%, from about 8% to about 12% or from about 8% to about 10% based on the total weight of the fabric conditioner composition.
E12 The use according to any of the preceding embodiments, wherein the cationic surfactant is selected from the group consisting of bis(Acyloxyethyl)hydroxyethyl Methylammonium Methosulphate, Dipalmoylethyl hydroxyethylmonium methosulfate, dihydrogenated tallow hydroxyethylmonium methosulfate, distearoylethyl hydroxyethylmonium methosulfate, dioleoyl ethyl hydroxyethylmonium methosulfate alkyl quaternary ammonium compounds, alkoxylated quaternary ammonium (AQA) compounds, ester quats, and combinations thereof.
E13 The use according to any of the preceding embodiments, wherein the fragrance contains more than 25 wt %, still more particularly more than 35 wt %, still more particularly more than 45 wt %, still more particularly more than 50, 60, 70 or 75 wt % of perfume ingredients, having a Clog P higher than 2.5 and lower than 7, more particularly lower than 6.
E14 The use of a fabric conditioner composition for improving the deposition of fragrance onto a textile, wherein the conditioner composition comprises a cationic surfactant, fragrance and an enzyme having cellulase activity.
E15 A method of increasing the deposition of a fragrance from a fabric conditioner composition onto a textile treated with the fabric conditioner composition, the method comprising the step of adding a enzyme having cellulase activity to the fabric conditioner composition.
E16 The method according to E15 wherein the enzyme having cellulase activity is selected from glycoside hydrolase family 5 (GH5), glycoside hydrolase family 7 (GH7), glycoside hydrolase family 12 (GH12), glycoside hydrolase family 44 (GH44) and glycoside hydrolase family 45 (GH45).
E17 The method according to any of E15 and E16, wherein the cellulase has at least 60% sequence identity to any of SEQ ID NO:1, SEQ ID NO:2, SEQ ID NO:3, SEQ ID NO:4, SEQ ID NO: 5, SEQ ID NO: 6, SEQ ID NO: 7, or SEQ ID NO: 8.
E18 The method according to any of E15 to E17 wherein the cellulase is present in an amount of 0.05 wt % to 2 wt % based on the total weight of the fabric conditioning composition.
E19 The method according to any of E15 to E18 method claims wherein the cellulase is present in an amount of 0.5 wt % to 25 wt % based on the dry matter weight of the fabric conditioner.
E20 The method according to any of E15 to E19 method claims, wherein the fabric conditioner composition comprises a cationic surfactant in an amount of 0.5 wt % to 40 wt % based on the total weight of the fabric conditioner composition.
E21 The method according to any of E15 to E20, wherein the cationic surfactant is selected from the group consisting of bis(Acyloxyethyl)hydroxyethyl Methylammonium Methosulphate, Dipalmoylethyl hydroxyethylmonium methosulfate, dihydrogenated tallow hydroxyethylmonium methosulfate, distearoylethyl hydroxyethylmonium methosulfate, dioleoyl ethyl hydroxyethylmonium methosulfate alkyl quaternary ammonium compounds, alkoxylated quaternary ammonium (AQA) compounds, ester quats, and combinations thereof.
E22 The method according to any of E15 to E21, wherein the fragrance contains more than 25 wt %, still more particularly more than 35 wt %, still more particularly more than 45 wt %, still more particularly more than 50, 60, 70 or 75 wt % of perfume ingredients, having a Clog P higher than 2.5.

The invention will be further explained and illustrated with reference to the following non-limiting examples.

### EXPERIMENTAL

### Example 1

### Measuring The Deposition Of Perfume Oil On Textile

The experiments are carried out using a liquid fabric softener model base containing about 8% dry matter content.

Three test samples are explored: The first is the model base; the second is the model base diluted by 50% with water; and the third is the model base diluted by 50% with water, to which the cellulase of SEQ ID NO:4 is added at 0.1 wt % based on the total weight of the fabric conditioner composition.

A perfume oil is incorporated at the same dosage (1.11 wt %) into the three model base test samples, and the samples are left for 24h to macerate before use.

Washing is performed in European front-loading washing machines. The wash load comprises cotton terry towels, T-shirts (100% polyester and T-shirt 95% cotton 5% lycra). The wash-load was 1.1 kg.

Pentane extraction is performed with a SpeedExtractor (Buchi) to measure the perfume deposition on the garments. A known amount of material from the washed garments is placed in the SpeedExtractor. The solvent (pentane) under pressure is used to extract the material. Methyl decanoate (50 μL of 10000 ppm solution or 0.5 mg) is used as internal standard.

Extracted samples are injected according to the “Splitless” Method in a GC/MS/FID (Agilent GC 7890A-MS5975C) for perfume identification and quantification with the internal standard.

The fragrance profile and intensity are assessed by an expert panel directly on wet fabrics in a time frame of 30 minutes to 2 hours after the wash program.

The intensity is rated on a 6 point scale, differences are significant if there is at least 0.5 intensity difference.

| Samples | Deposition wet | Olfactive assessment |
|---|---|---|
| Fragrance in model base | 261 μg/g ± 10% | wet: greasy smell |
| | | from the base |
| | | (intensity: 3) |
| Fragrance in 50% diluted | 259 μg/g ± 10% | wet: more aldehydic |
| model base | | (intensity: 3) |
| Fragrance in 50% diluted | 305 μg/g ± 10% | wet: best volume |
| model base containing | | (intensity: 3.5) |
| enzyme | | |

The results demonstrate that there is a significant increase in deposition of perfume oil on textile as a result of the use of a cellulase enzyme. This is the case, even when the amount of cationic surfactant in the fabric conditioner composition is reduced by 50%. From the sensorial study, the use of the cellulase enzyme leads to a significant increase in the perceived intensity of the perfume oil on the textile.

1-17. (canceled)

18. A method of improving the deposition of a fragrance onto a textile from a consumer product composition, the method comprising the step of contacting the textile with a consumer product composition comprising an enzyme having cellulase activity and a fragrance.

19. The method of claim 18, wherein improving the deposition of the fragrance comprises increasing the deposition of the fragrance on the textile.

20. The method of claim 19, wherein the improving is relative to a method comprising a step of contacting the textile with a consumer product composition not comprising an enzyme having cellulase activity.

21. The method of claim 18, wherein the enzyme having cellulase activity is selected from glycoside hydrolase family 5 (GH5), glycoside hydrolase family 7 (GH7), glycoside hydrolase family 12 (GH12), glycoside hydrolase family 44 (GH44) and glycoside hydrolase family 45 (GH45).

22. The method of claim 18, wherein the cellulase has at least 60% sequence identity to any of SEQ ID NO:1, SEQ ID NO:2, SEQ ID NO:3, SEQ ID NO:4, SEQ ID NO: 5, SEQ ID NO: 6, SEQ ID NO: 7, or SEQ ID NO: 8.

23. The method of claim 22, wherein the cellulase has at least 65% sequence identity to any of SEQ ID NO:1, SEQ ID NO:2, SEQ ID NO:3, SEQ ID NO:4, SEQ ID NO: 5, SEQ ID NO: 6, SEQ ID NO: 7, or SEQ ID NO: 8.

24. The method of claim 22, wherein the cellulase has at least 70% sequence identity to any of SEQ ID NO:1, SEQ ID NO:2, SEQ ID NO:3, SEQ ID NO:4, SEQ ID NO: 5, SEQ ID NO: 6, SEQ ID NO: 7, or SEQ ID NO: 8.

25. The method of claim 22, wherein the cellulase has at least 80% sequence identity to any of SEQ ID NO:1, SEQ ID NO:2, SEQ ID NO:3, SEQ ID NO:4, SEQ ID NO: 5, SEQ ID NO: 6, SEQ ID NO: 7, or SEQ ID NO: 8.

26. The method of claim 22, wherein the cellulase has at least 90% sequence identity to any of SEQ ID NO:1, SEQ ID NO:2, SEQ ID NO:3, SEQ ID NO:4, SEQ ID NO: 5, SEQ ID NO: 6, SEQ ID NO: 7, or SEQ ID NO: 8.

27. The method of claim 22, wherein the cellulase has at least 95% sequence identity to any of SEQ ID NO:1, SEQ ID NO:2, SEQ ID NO:3, SEQ ID NO:4, SEQ ID NO: 5, SEQ ID NO: 6, SEQ ID NO: 7, or SEQ ID NO: 8.

28. The method of claim 22, wherein the cellulase has at least 99% sequence identity to any of SEQ ID NO:1, SEQ ID NO:2, SEQ ID NO:3, SEQ ID NO:4, SEQ ID NO: 5, SEQ ID NO: 6, SEQ ID NO: 7, or SEQ ID NO: 8.

29. The method of claim 18, wherein the cellulase is present in an amount of 0.05 wt % to 2 wt % based on the total weight of the consumer product composition.

30. The method of claim 18, wherein the cellulase is present in an amount of 0.5 wt % to 25 wt % based on the dry matter weight of the consumer product composition.

31. The method of claim 18, wherein the consumer product composition comprises a cationic surfactant in an amount of 0.5 wt % to 40 wt % based on the total weight of the consumer product composition.

32. The method of claim 18, wherein the cationic surfactant is selected from the group consisting of bis(Acyloxyethyl)hydroxyethyl Methylammonium Methosulphate, Dipalmoylethyl hydroxyethylmonium methosulfate, dihydrogenated tallow hydroxyethylmonium methosulfate, distearoylethyl hydroxyethylmonium methosulfate, dioleoyl ethyl hydroxyethylmonium methosulfate alkyl quaternary ammonium compounds, alkoxylated quaternary ammonium (AQA) compounds, ester quats, and combinations thereof.

33. The method of claim 18, wherein the fragrance contains more than 25 wt %, still more particularly more than 35 wt %, still more particularly more than 45 wt %, still more particularly more than 50, 60, 70 or 75 wt % of perfume ingredients, having a Clog P higher than 2.5.

34. The method of claim 18, wherein the consumer product composition is a detergent, a fabric conditioner composition or a scent booster composition.
